(19) United States
(12) Patent Application Publication
(10) Pub. No.: US 2011/0258312 A1
(43) Pub. Date: Oct. 20, 2011

(54) SYSTEM AND METHOD FOR MONITORING AND CONTROLLING SERVER SYSTEMS ACROSS A BANDWIDTH CONSTRAINED NETWORK

(76) Inventors: Gregory Charles Herlein, San Francisco, CA (US); Robert Boyd, SanBruno, CA (US)

(21) Appl. No.: 12/998,983

(22) PCT Filed: Dec. 22, 2008
(86) PCT No.: PCT/US08/13951

§ 371 Date: Jun. 21, 2011

(51) Int. Cl. G06F 15/173

(52) U.S. Cl. 709/224

(57) ABSTRACT

A method, an apparatus comprising a network manager and a system for communicating with at least one server across a network includes at least one group identifier unit for determining if a communication is intended for a server by determining if a unique identifier included with a communication received by the server identifies a group in which the server is a member. In at least one embodiment, the network manager is configured to define at least one group of servers, determine a unique identifier for the at least one group of servers and include, with a communication to the servers connected to the network, the determined unique identifier for the group of servers for which the communication is intended. Accordingly, a communication is only accepted by a server which is identified as a member of the intended group of servers for which a communication is intended.

### CROSS-REFERENCE TO RELATED APPLICATIONS

This application is related to U.S. Patent Provisional Application No. 60/921,714, filed on Apr. 4, 2007 in the USPTO and International Patent Application serial no. PCT/US07/013,949, filed on Jun. 13, 2007 in the PCT and claiming priority to the U.S. Patent Provisional Application No. 60/921,714, both entitled “Device Group Control”, which are herein incorporated by reference in their entireties.

### FIELD OF THE INVENTION

The present invention generally relates to system monitoring and control and, more particularly, to a method, apparatus and system for controlling networked systems across a bandwidth constrained network at a group level.

### BACKGROUND OF THE INVENTION

The control of networked devices across of an Internet Protocol (IP) network such as a Local Area Network (LAN) typically takes the form of sending specific commands to specific, intended devices. Aggregating such devices into groups typically is accomplished using application software. Such solutions create software complexity and may be unsuitable for a desired system behavior due to the sequential nature of such solutions.

In addition to LANs, systems comprising multiple servers may be distributed over large wide area networks (WAN), for example, via an IP-over-satellite network, which typically have an extremely limited two-way bandwidth.

For example, video server systems deployed for out of home/retail advertising use are usually loosely connected back to central headquarters. The network connection is sometimes over VSAT (Very Small Aperture Terminal) in which case it is a single, shared two-way connection across all the sites, often sized at less than 1 Mb/sec. If VSAT is not used, the connection is limited to either a low speed DSL line or is connected through the retailer's network across a VPN (Virtual Private Network). The VPN is also a shared resource at usually under 1 Mb/sec. This highly constrained network connection presents serious challenges to monitoring and control of a complex server network.

Exemplary kinds of operations that are often required for system monitoring and control include (but are not limited to):

checking how much disk space is used and/or available

checking if all the required processes are running

checking if a specific media file is available and/or playing

checking if all the right media files have played

checking on the general health of the server and video system components

instructing the server to not play certain media files, or to delete certain files

instructing the server to play a broadcast stream instead of local playback

Today's systems provide these instructions by connecting to each server in sequence and making the transaction, or, by running a software agent on the server that connects back to a central host. Either approach is highly inefficient across a shared low throughput network link. That results in simple operations taking long periods of time and effectively limits the amount of operations that can be performed.

### SUMMARY OF THE INVENTION

Embodiments of the present invention address the deficiencies of the prior art by providing a method, apparatus and system for monitoring and controlling server systems across a bandwidth constrained network by, in various embodiments, implementing grouping and multicasting processes.

In one embodiment of the present invention, a method for communicating with at least one system across a network includes defining at least one group of systems, determining a unique identifier for each of the at least one group of systems, and including with a communication to systems connected to the network, the determined unique identifier for at least one group of systems for which the communication is intended. In the described method of the present invention, the communication is only accepted by a system confirming that the included unique identifier included with the communication identifies a group in which the system is a member.

In an alternate embodiment of the present invention, an apparatus for communicating with at least one system across a network includes a network manager configured for performing the steps of defining at least one group of systems, determining a unique identifier for each of the at least one group of systems, and including with a communication to systems connected to the network, the determined unique identifier for at least one group of systems for which the communication is intended. In the described apparatus of the present invention, the communication is only accepted by a system confirming that the included unique identifier included with the communication identifies a group in which the system is a member.

In an alternate embodiment of the present invention, a system for communicating with at least one server across a network includes at least one server connected to the network for receiving and forwarding communications, at least one group identifier unit for determining if a communication is intended for a respective server by determining if a unique identifier included with a communication received by the server identifies a group in which the server is a member and a network manager configured for performing the steps of, defining at least one group of servers, determining a unique identifier for the at least one group of servers and including with a communication to the at least one server connected to the network, the determined unique identifier for at least one group of servers for which the communication is intended.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in accordance with an embodiment of the present invention;

FIG. 2 depicts a high level block diagram of a retail advertising network including a retail network manager (RNM) in accordance with an embodiment of the present invention;

FIG. 3 depicts an exemplary header for a protocol design in accordance with an embodiment of the present invention;

FIG. 4 depicts an exemplary base protocol profile in accordance with an embodiment of the present invention;

FIG. 5 depicts an exemplary header for a protocol design in accordance with an alternate embodiment of the present invention;

FIG. 6 depicts an exemplary base protocol profile in accordance with an alternate embodiment of the present invention;

FIG. 7 depicts a high level block diagram of a system for controlling and monitoring groups of server systems in accordance with an embodiment of the present invention; and

FIG. 8 depicts a flow diagram for controlling and monitoring server systems in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

Embodiments of a method, apparatus and system for monitoring and controlling server systems across a bandwidth constrained network are provided. Although the present principles will be described primarily within the context of communications across a retail advertising network, the specific embodiments of the present principles should not be treated as limiting the scope of the invention. It will be appreciated by those skilled in the art and informed by the teachings of the various embodiments of the present invention that the concepts of the present principles can be advantageously applied in other environments in which server system control across wide area networks is desired such as in two-way satellite systems and Virtual Private Network links.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

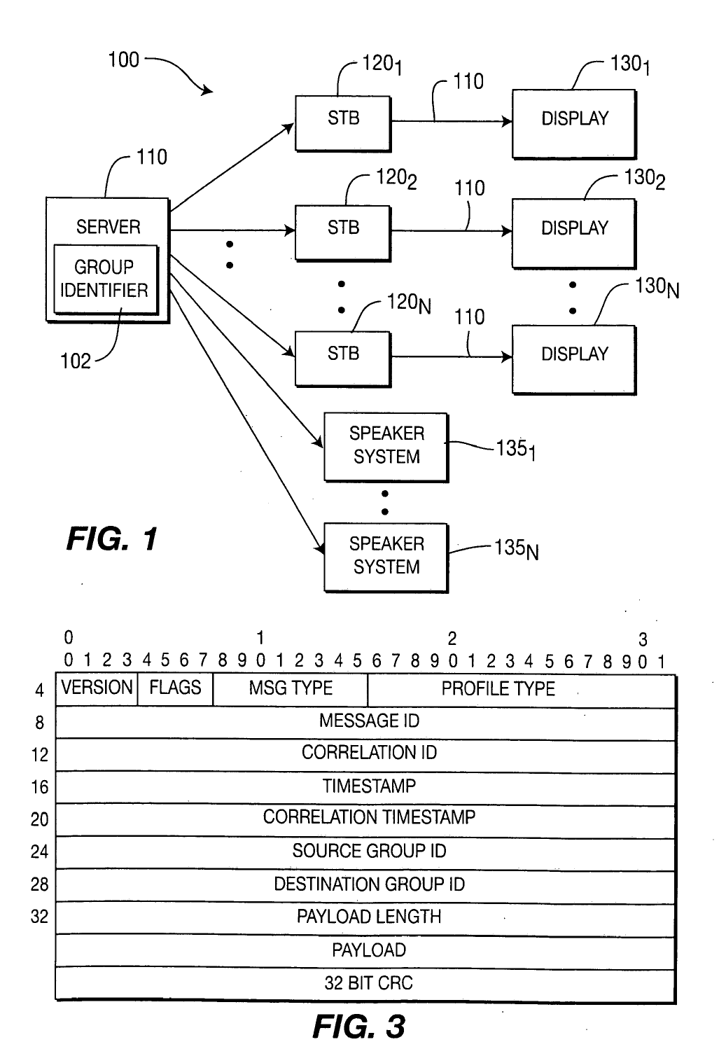

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudo code, and the like represent various processes which may be substantially represented in computer readable media and so executed by a computer or processor, whether or not such computer or processor is explicitly shown. FIG. 1 depicts a high level block diagram of a content distribution system. The content distribution system 100 of FIG. 1 illustratively comprises at least one server 110 having a group identifier unit 102, a plurality of receiving devices such as tuning/decoding means (illustratively set-top boxes (STBs)) 120₁-120ₙ, and a respective display 130₁-130ₙ for each of the set-top boxes 120₁-120ₙ, and other receiving devices, such as audio output devices (illustratively speaker systems) 135₁-135ₙ. Although in the system 100 of FIG. 1, each of the plurality of set-top boxes 120₁-120ₙ, is illustratively connected to a single, respective display, in alternate embodiments of the present principles, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present principles, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as audio, video and/or audio/video content.

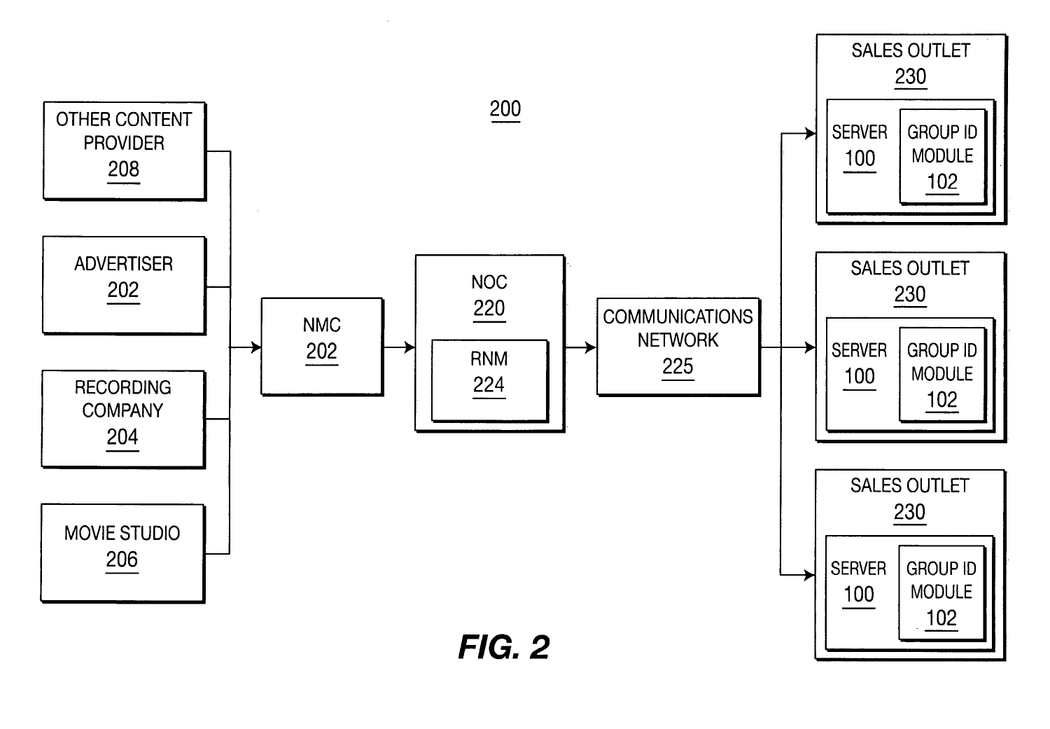

In one embodiment, the content distribution system 100 of FIG. 1 can be a part of a retail advertising network. For example, FIG. 2 depicts a high level block diagram of a retail advertising network including a retail network manager (RNM) 224 for providing retail advertising according to an aspect of the present principles. In the advertising network 200 of FIG. 2, the advertising network 200 and server system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG2, MPEG4/MPEG4 Part 10/AVC-H.264, VC-1, Windows Media, etc.), although the present system should not be limited to using only those formats.

In one embodiment, software for controlling the various elements of the in-store advertising network 200 and the content distribution/server system 100 can include a 32-bit operating system using a windowing environment (e.g., MS-Windows™ or X-Windows™ operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store s.

As depicted in FIG. 2, the content for the retail advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site (e.g., within a particular store).

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files can be compressed and transferred separately, or a streaming compression program of some type employed.

In the illustrated embodiment of FIG. 2, the NOC 220 includes a Retail Network Manager (RNM) 224 for defining a particular group of servers to be monitored and/or controlled as a unit. That is, in one embodiment of the present invention, servers can be grouped by the RNM 224 according to a Device Group Control Protocol (DGCP) described in a commonly owned Provisional Patent Application Ser. No. 60/921,714, filed on Apr. 4, 2007 in the USPTO and an International Patent Application serial no. PCT/US07/013,949, filed on Jun. 13, 2007 in the PCT and electing the U.S., both entitled “Device Group Control”, which are herein incorporated by reference in their entireties.

That is, in accordance with the Device Group Control Protocol, each server can be configured to belong to at least one group—itself—and can also belong to many other groups. As such, commands or requests can be targeted by group—which can contain one or a plurality of servers. Each server of a group will, as such, transmit and receive using the same broadcast or multicast channel. In various embodiments of the above described invention, servers can support being members of as many groups as desired. In addition, servers can be configured to be members of or not members of groups either by using the protocol or by external means, such as configuration files or other transactions such as (Simple Network Management Protocol) SNMP or web configuration pages. In various embodiments of the present invention, servers can be grouped according to a commonality such as all stores within a certain zip code, all stores within a time zone, all stores within a particular state, all stores within a particular region, a demographic characteristic and the like. Groups of systems can be assigned a unique identifier and then communicated with, monitored and controlled as a unit.

In the embodiment of FIG. 2, the Retail Network Manager (RNM) 224 comprises a network control device. This device can be configured to query the store servers on a periodic basis or to make periodic control operations of store servers. In addition, the RNM 224 provides a simple network software interface to allow other software to control and monitor the store servers. In the above described embodiment, the RNM 224 acts like a network proxy having standard network connections on the Enterprise side and DGCP network protocol communications on the store side. Commands and queries can be targeted to groups using their group identifier or by some other unique identifier that maps to a unique group. For example, in one embodiment of the present invention, the group identifiers can include a zip code, telephone area code, advertising DMA code, or other logical grouping that maps to a collection of store servers.

Referring back to FIG. 2, the NOC 220 communicates digitized data files 222 to each associated server/content distribution system 100 at a commercial sales outlet 230 via a communications network 225. Each server 100 includes a group identifier unit 102 configured for enabling the server to examine an incoming message (e.g., from NOC 220) to determine if the server belongs to a target group to which the message applies.

In accordance with various embodiment of the present invention, the communications network 225 can be implemented in any one of several technologies. For example, in one embodiment of the present invention, the communications network 225 can comprise a satellite link (satellite IP network) to distribute digitized data files 222 to each applicable server system 100 of, for example, commercial sales outlets 230. Such a configuration advantageously enables content to be distributed by multicasting the content to various locations simultaneously. Alternatively, the Internet can be used to both distribute audiovisual content to and allow feedback from commercial sales outlets 230. Other techniques and configurations for implementing the communications network 225, such as using leased lines, a microwave network, or other such mechanisms can also be used in accordance with alternate embodiments of the present invention.

Although in the embodiment described above, the RNM 224 is described as a controller for implementing the protocol and inventive aspects of the present principles, in alternate embodiments of the present invention, a separate controller can be provided for implementing the protocol and inventive aspects of the present principles.

At the local level (e.g., in-store), the server 110 of the content distribution system 100 is capable of receiving content (e.g., distribution packs) and, accordingly, distribute them in-store to the various receivers such as the set-top boxes 120 and displays 130 and the speaker systems 135. That is, at the content distribution system 100, content is received and configured for streaming. The streaming can be performed by one or more servers configured to act together or in concert. The streaming content can include content configured for various different locations or products throughout the sales outlet 230 (e.g., a store). For example, respective set-top boxes 120 and displays 130 and various speaker systems 135 can be located at specific locations throughout the sales outlet 230 and respectively configured to display content and broadcast audio pertaining to products located within a predetermined distance from the location of each respective set-top box and display.

The server 110 of the content distribution system 100 receives content and creates various different streams (e.g., content channels) of text, audio, video and/or audio/video to be communicated to the various receivers throughout the store. The streams can be individual channels of modulated audio, video and/or audio/video onto a radio frequency distribution or transmitted as data flows within a unicast or multicast internet protocol (IP) network. These streams can originate from one or more servers under the same logical set of control software.

At the local area network level (within each store), one or more of the receivers can be configured to receive a specific one of the created streams and as such forming groups of receivers. In accordance with the present principles, the server 110 implements a control protocol designed for use in, for example, the broadcast (e.g., local area network using layer 2 broadcast) or multicast environment of, for example, the content distribution system 100 of FIG. 1 such that devices, such as the receiving devices of FIG. 1, can be configured in a way that allows the devices to be controlled and/or monitored in groups. That is, the protocol targets devices at an ‘application layer’ and not at a ‘network layer’. Some of the functional parameters of devices that can be controlled can include power state, channel, volume and the like. As described above, each server 100 is configured to belong to at least one group—itself—and can also belong to many other groups. As such, commands or requests can be targeted by group—which can contain one or a plurality of server systems 100. Each server 100 of a group of servers will, as such, transmit and receive using the same multicast channel.

In one embodiment of the present invention, every server automatically belongs to a group of one—its own group based on its identifier. That is, a “group” of systems is defined herein as comprising at least one server, though it can also comprise a plurality of servers. For example, a server's unicast IP address can be used as its unique ID. In accordance with an embodiment of the present principles, one requirement for a server's ID is that the server address be unique among that broadcast or multicast address. Servers can support being members of as many groups as desired. In addition, servers can be configured to be members of or not members of groups either by using the protocol or by external means, such as configuration files or other transactions such as (Simple Network Management Protocol) SNMP or web configuration pages. For example, in various embodiments of the present principles, it is possible that a given domain of the present principles can share an IP network with other domains. In addition, it is highly likely that a given domain can wish to enforce message authentication and/or message integrity through the use of an MAC message digest scheme. These two requirements feed the need for the two configurable parameters for a system group control protocol of the present principles such as a MAC shared secret and a Multicast IP address. However, some applications of the present principles can find it highly desirable to also pre-configure group membership. The protocol supports dynamic membership but in some embodiments can add a level of complexity to the control software that limits some of the purpose of the protocol of the present principles. Configuring servers to be a part of a group allows the control software to be drastically less complex.

As such, in one embodiment of the present principles, servers 100 are configured to know to which group or groups they belong. When a control/configuration message having a group identification information is received, the server software examines the message to determine which group(s) of servers the message is intended for. If the server is a member of the group that the message is addressed to then the server will process the payload of that message.

Embodiments of the present principles support profiles that can be customized for different applications. For example, in one embodiment of the present principles, a profile can include a ‘retail advertising profile’ that defines a set of commands appropriate for a network implemented for advertising in retail stores. In addition, other profiles can support the particular needs of institutions like hospitals, airports, or movie theatres. A profile design of the present principles can include a common header and a variable profile payload. For example, FIG. 3 depicts an exemplary header for a protocol design in accordance with an embodiment of the present invention. The header of FIG. 3 illustratively comprises a version section, a flag section, a message type section, a message ID and correlation ID section, a profile type section, an addressing section, and a timestamp section. FIG. 3 further comprises a payload section and a Cyclic Redundancy Check (CRC) section.

In the header of FIG. 3, the version section provides a means to increment the version number as the protocol evolves. In the example header of FIG. 3, the version is illustratively 0x01. The flag section of the header of FIG. 3 illustratively comprises four bits reserved for flags. The bits are A, B, C and D (from most to least significant in order). In the header of FIG. 3, the A bit is defined to mean ‘Do Not Reply.’ If this flag is set, a device processing the message does not need to reply to the message. All other flag bits are illustratively reserved. In the message type section, the following message types are illustratively defined:

0x01 Request (Command);

0x02 Response;

0x03 Alarm;

All other values are reserved.

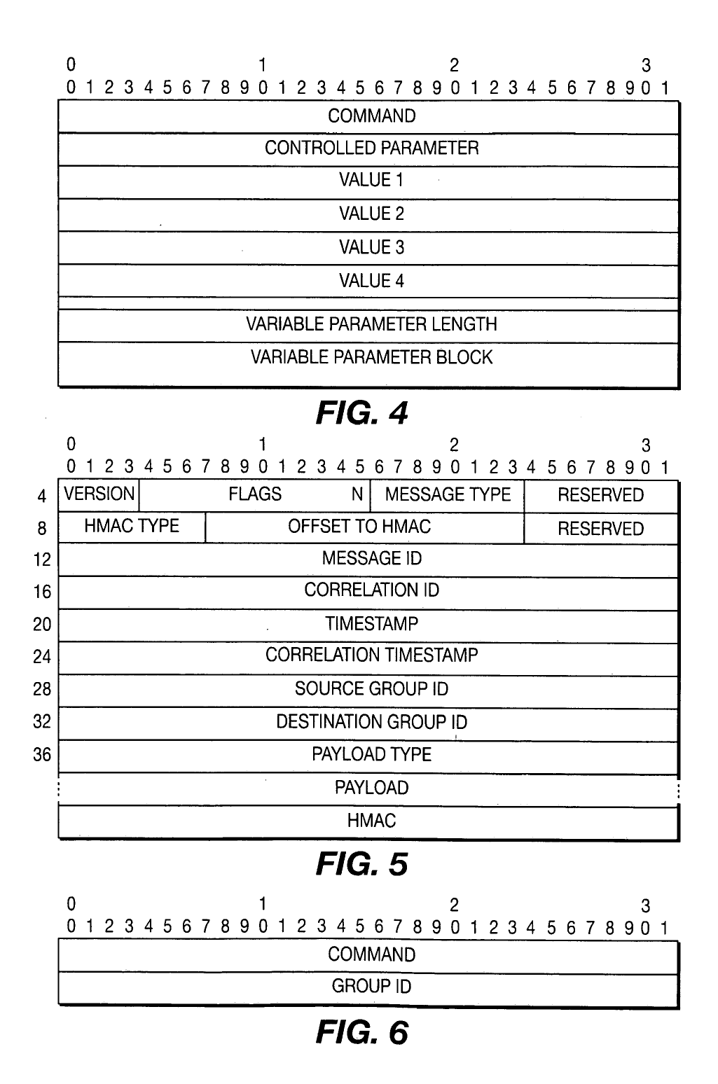

In the message ID and correlation ID section, unless the ‘do not reply’ flag is set, a device that gets a Request message must reply to that message. The reply shall set the correlation id field to equal the message id field of the message being replied to. Request messages shall have the correlation id field set to zero (0). Message IDs shall be initially set to a random value and then incremented by one for each sequential message sent by that device. Prevention of collisions in Message ID numbering is done by the use of the correlation timestamp (described below). In the profile type section, profiles are enumerated. That is, profile types can enumerated for different applications including but not limited to a retail advertising network, a hospital network, airport networks, movie theatres, etc. For example, in the example profile header of FIG. 3, a profile ID of 0 (zero) is defined as the core profile, which is described below with reference to FIG. 4.

The addressing section of the header of FIG. 3 includes ‘Group ID” numbers. That is, as described above, in one embodiment of the present principles, every network device has a unique ID that applies only to that device. However, a given device can be assigned to as many groups as desired. In one embodiment of the present principles, these addresses are 32 bit values.

In the timestamp section of the header of FIG. 3, a timestamp is included. That is, in the embodiment of FIG. 3, the timestamp must be set on all messages sent. In one embodiment of the present principles, the timestamp is a 32 bit value that represents, for example, the number of seconds elapsed since Jan. 1, 1970 (i.e., Unix time). The timestamp of all messages shall be the system time that a request was generated. In one embodiment, initially, the correlation timestamp of all Request messages shall be set to zero (0). The correlation timestamp of all Reply messages shall be the timestamp from the associated Request message. Devices matching reply messages to the Request message must ensure that the correlation timestamp also matches the timestamp of the Request. This prevents collisions in message replies due to random numbers on startup overlapping with previous instances messages.

In the illustrated embodiment of FIG. 3, the payload length section identifies the length of bytes in the payload. Its purpose is strictly to determine the location of the Cyclic Redundancy Check. That is, the Cyclic Redundancy Check section of FIG. 3 includes a 32 bit Cyclic Redundancy Check of all bytes up to and including the last byte of the payload.

FIG. 4 depicts an exemplary base protocol profile in accordance with an embodiment of the present invention. The base protocol profile of FIG. 4 illustratively includes a command section, a controlled parameter section, a plurality of value sections (illustratively four value sections), a variable length section and a variable parameter block section. The base protocol profile of FIG. 4 can be modified in accordance with the present invention to apply to various applications. For example, for a retail advertising application, the command section can include the following commands:

0x01 subscribe to group (in ‘controlled parameter’ field);

0x02 unsubscribe to group (in ‘controlled parameter’ field); and

0x03 unsubscribe to all groups (except self group).

In addition for a retail advertising application, the controlled parameter section can include the following defined values:

0x01 power state;

0x02 channel;

0x03 volume; and

0x04 mute.

The power state values can include a respective “on” (e.g., binary ‘1’) and “off” (e.g., binary ‘0’) value; the channel value can include an indication of whether the channel comprises an IPTV channel (e.g., binary ‘0’) or an RF channel (e.g., binary ‘1’); the volume value can include a number representative of a value between 0 and 100 percent; and the mute value can include a respective “on” (e.g., binary ‘1’) and “off” (e.g., binary ‘0’) value.

FIG. 5 depicts an exemplary header for a protocol design in accordance with an alternate embodiment of the present invention. In the header of FIG. 5, the version section provides a means to increment the version number as the protocol evolves. In the example header of FIG. 5, the version is illustratively 0x01. The flag section of the header of FIG. 5 illustratively comprises twelve bits reserved for flags. In the embodiment of FIG. 5, the least significant bit is defined to mean ‘Do Not Reply’ and is called the ‘N’ bit. If this flag is set, a device processing the message does not need to reply to the message. All other flag bits are illustratively reserved. In the message type section, the following message types are illustratively defined:

0x00 Notification

0x01 Request (Command);

0x02 Response;

0x03 Alarm;

All other values are reserved.

The HMAC section, defines the Hashed Message Authentication Code (HMAC) used with the message. The following values are illustratively defined:

0x00 None

0x01 CRC32 (for message integrity only)

0x02 HMAC-MD5 (RFC 2202)—80 bit length

0x03 HMAC-SHA1 (RFC 2202)—80 bit length.

The offset to HMAC section defines an offset from the start of the group protocol frame of the present principles to the first byte of the HMAC. If no HMAC is used this value is ignored.

In the message ID and correlation ID section, unless the ‘do not reply’ flag is set, a device that receives a Request message must reply to that message. The reply shall set the correlation id field to equal the message id field of the message being replied to. Request messages shall have the correlation id field set to zero (0). Message IDs shall be initially set to a random value and then incremented by one for each sequential message sent by that device. Prevention of collisions in Message ID numbering is done by the use of the correlation timestamp (described below).

In the embodiment of FIG. 5, every protocol device has at least one individual address and zero or more group addresses. The individual address is called the ‘Individual ID” and the group addresses are called “Group IDs.” These addresses are illustratively 32 bit values in the embodiment of FIG. 5 and identified in the source group ID and destination group ID sections.

In the timestamp section of the header of FIG. 5, a timestamp is included. That is, in the embodiment of FIG. 5, the timestamp must be set on all messages sent. In one embodiment of the present principles, the timestamp is a 32 bit value that uses the Internet Group Management protocol (IGMP) timestamp format. The 32 bits are an unsigned integer representing the number of milliseconds since midnight Universal time (on the host). The timestamp of all messages shall be the system time that a request was generated. In one embodiment, initially, the correlation timestamp of all Request messages shall be set to zero (0). The correlation timestamp of all Reply messages shall be the timestamp from the associated Request message. Devices matching reply messages to the Request message must ensure that the correlation timestamp also matches the timestamp of the Request. This prevents collisions in message replies due to random numbers on startup overlapping with previous instances messages. For example, it is possible that a controller of the present invention could be operational and issuing messages and then fail and subsequently restart. On restart it is possible that the controller can re-use message ID numbers that have been issued already and not yet responded to. The controller can detect such collisions by verifying that the correlation timestamp also matches the timestamp of the Request.

Another benefit of the reply timestamp is that it can be used as a crude measure of timing for the performance of a given function. Assuming the devices and controller are somewhat time synchronized (using Network Time Protocol for example) then the reply message contains the timestamp from the original request and the reply. The difference between the two is the time required for the closed loop function to be performed (in seconds). This can be useful as a means to easily observe system performance.

Referring back to FIG. 5, the payload type section identifies payload types for different applications including but not limited to a retail advertising network, a hospital network, airport networks, movie theatres, etc. For example, in FIG. 5, the payload types can include the following:

0x00 Core protocol payload (described with respect to FIG. 6);

0x01 Set Top Box Control Payload

0xFF000001 Retail Network Server Monitoring and Control

For example, FIG. 6 depicts an exemplary base protocol profile in accordance with an alternate embodiment of the present invention. In one embodiment, the command section of the base protocol of FIG. 6 can include the following commands:

0x00 group clear—unsubscribe to all groups (except self group)

0x01 subscribe to group;

0x02 unsubscribe to group;

0x03 enumerate group membership; and

0x04 heartbeat.

The group clear command is used to command a device(s) to specifically forget all group memberships it currently has (except self group. The Subscribe command is used to specifically subscribe a device (or group of devices) to a group. The Unsubscribe command is used to specifically unsubscribe a device (or group of devices) from a group. The Enumerate Group Membership command is used to query a device about to which groups it belongs. In one embodiment of the present invention, each contacted device will reply with a success or failure code and will then send a group membership notification message for each group of which it is a member. It should be noted that if this command is sent to a group rather than an individual device the number of replies could be very large since each device in the group would thus enumerate its group membership. The Heartbeat command is used to send a heartbeat message to a device or device group. Each device in the group must reply. This is a very useful tool to both ensure network connectivity as well as to enumerate group membership.

Referring back to FIG. 6, the group ID section identifies the group that for which the command is to take action. In the case of subscribe or unsubscribe commands, this is the group that is to be subscribed to or unsubscribed from. In the case of a group clear command this field is ignored.

With regards to the base protocol profile of FIG. 6, reply messages must set the command field to, for example, either a 0 (failure) or 1 (success) for the command requested. In addition and with regards to the base protocol of FIG. 6, alarm messages must have the ‘do not reply’ flag set. In one embodiment of the present principles, the command field can be set for the following alarm conditions:

0x00 unable to determine own group id (not configured or other similar error).

Even further and with regards to the base protocol profile of FIG. 6, notification messages must have the ‘do not reply’ flag set. In one embodiment of the present principles, the command field can be set for the following conditions:

0x00 DGCP software stack shutdown;

0x01 DGCP software stack startup; and

0x02 DGCP Group Membership Announcement.

In the embodiment of FIG. 6, the Software Stack Shutdown notification is sent when a device or controller is about to perform a normal shutdown. It provides and indication that the device is going offline. The Software Stack Initialized notification is sent on startup of the device or controller to signal that the device has restarted. If the device is not capable of initializing its group memberships, the controller may need to subscribe the device to the appropriate groups again. The Group Address Announcement notification is used as a means for a device to advertise its group membership. A device can announce its memberships on startup and in response to an “Enumerate Group Membership” command.

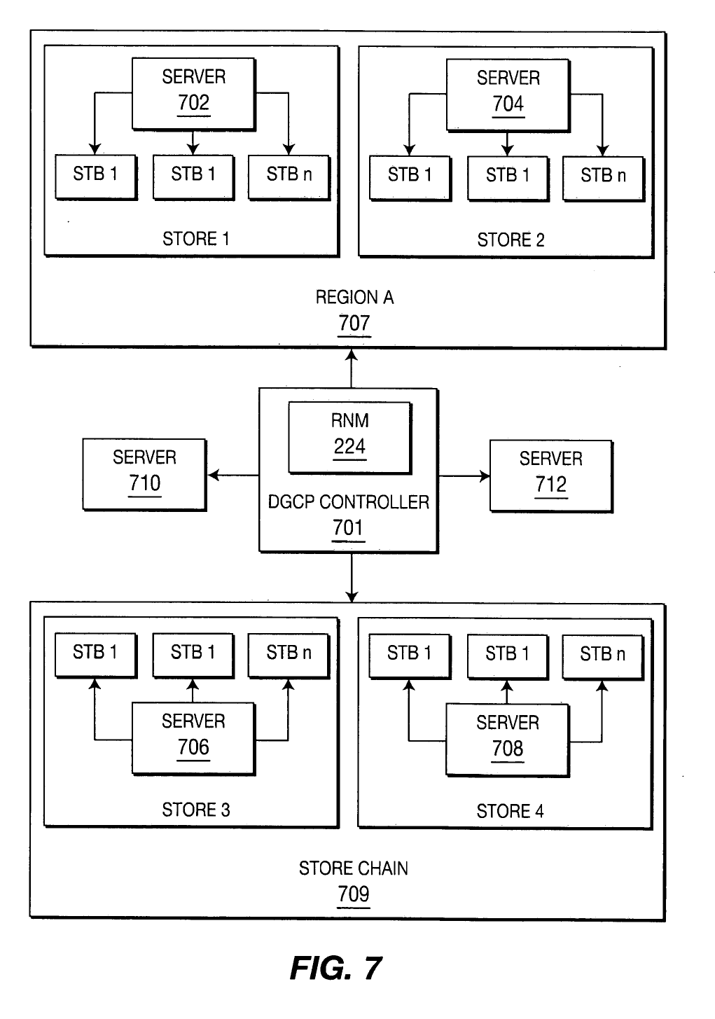

FIG. 7 depicts a high level block diagram of a system for controlling and monitoring groups of server systems in accordance with an embodiment of the present invention. For example, a DGCP controller 701 including a RNM 224 can be configured for communicating with all servers 702, 704, 706, 708, 710 and 712 across a network.

An example of one target group can comprise all servers within Region A (707). Region A (707) can include any number of servers (e.g., servers 702, 704 embodied in Store 1 and Store 2) organized in accordance with any desired criteria, e.g., a particular location, zip code, time zone, etc. All servers within Region A can be given a unique identifier to identify them as belonging to the “Region A target group.” In accordance with various embodiments of the present invention, servers 702 and 704 can have any number of receivers (STB1 . . . STBn) at their local area network sites.

In another example, DGCP controller 701 communicates with Store 3 and Store 4 (servers 706, 708) grouped together in accordance with the DGCP protocol as described above. For example, Store 3 and 4 can be grouped by store type or chain, stores which have a certain special feature, or any other grouping of stores which is desired to be monitored and/or controlled as a unit for any other reason. In the example above, stores 3 and 4 can belong to a particular “Store Chain” 709.

As previously described, each designated target group is given a unique ID number. For example, the controller 701 can form the following groups to which the respective servers can subscribe:

| Group Name | GroupID |
|---|---|
| Region A | 0x00000001 |
| Store Chain | 0x00000002 |
| All servers | 0x00000003. |

For example, the controller 701 can communicate a subscribe message to the servers of the respective groups such that the servers can become members of the respective groups of which they should belong determined by, e.g., at least their location and the content and information intended for respective servers. Every message (e.g., DGCP message) is multicast to all servers (e.g., in the example of FIG. 7, to all servers 702, 704, 706, 708, 710, 712) but is addressed to a target group. For example, assume that Group ID 0x00000001 is addressed.

In such a case, all the servers 702, 704, 706, 708, 710, 712 would receive the applicable commands but only servers assigned to group 0x00000001 (e.g., the servers 702, 704 shown in Region A) would execute the commands for that group. Each server can also execute a reply to the controller in response to an inquiry request. Examples of “inquiry requests” which can be sent from a controller 701 to a group of servers can include:
how much disk space and memory is in use at the moment?
what processes are running at the moment?
is this particular process running at the moment?
are you healthy?

Each server in an applicable group can then reply to an inquiry request with, in one embodiment, one packet to answer the inquiry.

Advantageously, a system and method according to the various described embodiment of the present invention essentially take bandwidth intensive Application program interface (API) calls and make them into DGCP defined messages that are far more bandwidth efficient. Unlike previous methods in which connection to each individual server in succession would be required to make an inquiry or send a message to servers across a wide area network, a system and method according to the present principles advantageously provides sending only one packet addressed to all servers (i.e., multicast) with each server in the addressed group being able to reply with one packet each. A system and method according to the present principles allows the creation of arbitrary groups and/or pre-defined groups—e.g., “all stores that are super centers” or “all stores in New York” or “all stores in the Central Time Zone”—and then enables efficient operation on that group.

Some examples of “control operations” include:
reboot
restart the software application
reboot all the set top boxes in the store
play a different (or no) media instead of X media

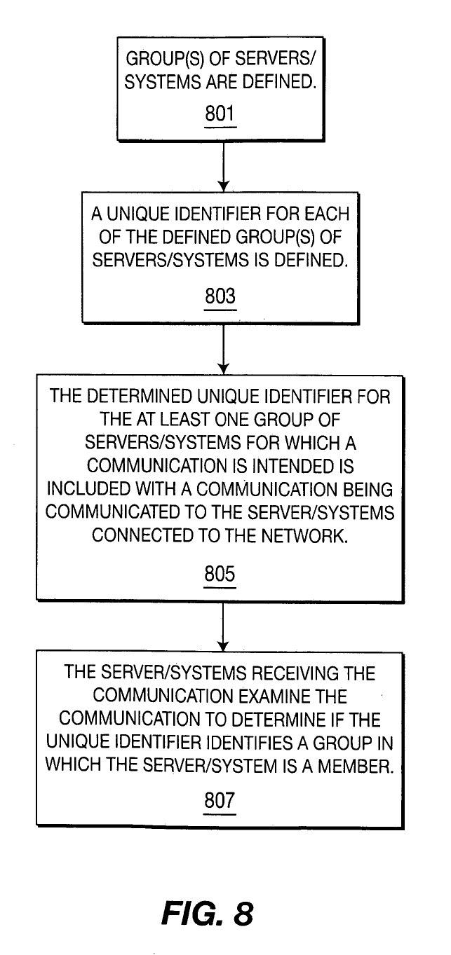

FIG. 8 depicts a flow diagram for controlling and monitoring server systems of a network in accordance with an embodiment of the present invention. The method begins at step 801 in which at least one group of servers which is desired to be monitored and/or controlled as a unit (i.e., a ‘target’ group) is defined. As described above, each ‘target group’ of servers can comprise at least one or a plurality of server(s)/server system(s), and can be defined by, for example, assigning a unique group identifier to each group. As described above, in one embodiment of the present invention, such groups are defined by the Retail Network Manager 224. The method proceeds to step 803.

At step 803, a unique identifier is determined for each of the groups of server systems. Again, as described above, in one embodiment of the present invention, such unique identifiers are determined by the Retail Network Manager 224. The method proceeds to step 805.

At step 805, the respective determined unique identifier for at least one group of servers for which a communication is intended is included with the communication being communicated to all of the server/server systems connected to the network. As described above, in one embodiment of the present invention each communication can include a command or message which includes, for example, a payload (essential data within each packet to be delivered). The method proceeds to step 807

At step 807, each of the server/server systems examine the communication to determine if the unique identifier included with the communication identifies a group in which the server/server system is a member and as such, for which the communication was intended. If so, the server/server system will process the payload of the message (i.e., execute an included command). For example, each server compares the unique group identifier in the received communication with any assigned unique group identifier for a group in which the server is included, and if a match exists, that server is designated as being part of the target group for which the communication was intended. As described above, in one embodiment of the present invention, a respective group identifier unit is included in each server/server system for determining if a communication is intended for the server/server system by determining if a unique identifier included with the communication identifies a group in which the server/server system is a member.

Having described various embodiments for a method, apparatus and system for monitoring and controlling server systems across a bandwidth constrained network, (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A method for communicating with at least one system across a network comprising the steps of:
defining at least one group of systems;
determining a unique identifier for the at least one group of systems; and
including with a communication to systems connected to the network, the determined unique identifier for at least one group of systems for which the communication is intended;
wherein the communication is only accepted by a system confirming that the included unique identifier included with the communication identifies a group in which the system is a member.

2. The method of claim 1, wherein each system is aware of each group of systems to which the system belongs and the unique identifier for each group of systems to which the system belongs.

3. The method of claim 1, where the communication comprises a command and the command is only processed by a system confirming that the included unique identifier included with the command identifies a group in which the system is a member.

4. The method of claim 3, wherein the command includes a payload.

5. The method of claim 1, wherein a system comprises at least one server system in a retail advertising network.

6. The method of claim 1, wherein systems are grouped according to at least one of a type of retail chain in which systems are located, a time zone in which systems are located, a zip code in which systems are located, a region in which systems are located, a state in which systems are located and a demographic characteristic of a location in which systems are located.

7. The method of claim 1, wherein the network comprises a bandwidth constrained network.

8. The method of claim 1, wherein said communication comprises multicasting at least one packet to all systems connected to the network.

9. An apparatus for communicating with at least one system across a network comprising:
a network manager configured for performing the steps of:
defining at least one group of systems;
determining a unique identifier for the at least one group of systems; and
including with a communication to systems connected to the network, the determined unique identifier for at least one group of systems for which the communication is intended;
wherein the communication is only accepted by a system confirming that the included unique identifier included with the communication identifies a group in which the system is a member.

10. The apparatus of claim 9, wherein the apparatus comprises a device group control protocol controller.

11. The apparatus of claim 9, wherein each system comprises a group identifier unit for determining if a communication is intended for the system by determining if a unique identifier included with the communication identifies a group in which the system is a member.

12. A system for communicating with at least one server across a network comprising:
at least one server connected to the network for receiving and forwarding communications;
at least one group identifier unit for determining if a communication is intended for a respective server by determining if a unique identifier included with a communication received by the server identifies a group in which the server is a member; and
a network manager configured for performing the steps of:
defining at least one group of servers;
determining a unique identifier for the at least one group of servers; and
including with a communication to the at least one server connected to the network, the determined unique identifier for at least one group of servers for which the communication is intended;
wherein a communication is only accepted by a server which is identified as a member of the intended group of servers.

13. The system of claim 12, wherein the network manager is configured to assign a unique group identifier for each defined group of servers.

14. The system of claim 12, wherein each server is aware of each defined group of servers to which the server belongs and the unique identifier for each group of servers to which the server belongs.

15. The system of claim 12, where the communication comprises a command and the command is only processed by a server confirming that the included unique identifier included with the command identifies a group in which the server is a member.

16. The system of claim 15, wherein the command includes a payload.

17. The system of claim 12, wherein a server comprises at least one server in a retail advertising network.

18. The system of claim 12, wherein servers are grouped according to at least one of a type of retail chain in which servers are located, a time zone in which servers are located, a zip code in which servers are located, a region in which servers are located, a state in which servers are located and a demographic characteristic of a location in which servers are located.

19. The system of claim 12, wherein the network comprises a bandwidth constrained network.

20. The system of claim 12, wherein said communication comprises multicasting at least one packet to all servers connected to the network.
